(19) United States
(12) Patent Application Publication
(10) Pub. No.: US 2005/0188174 A1
(43) Pub. Date: Aug. 25, 2005

(54) Extensible creation and editing of collections of objects

(75) Inventors: Chris J. Guzak, Kirkland, WA (US); Cornelis K. Van Dok, Bellevue, WA (US); David G. De Vorchik, Seattle, WA (US); Timothy P. McKee, Seattle, WA (US); Tyler K. Beam, Redmond, WA (US); Jeffrey Belt, Bellevue, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 11/108,743

(22) Filed: Apr. 19, 2005

Related U.S. Application Data
(63) Continuation-in-part of application No. 10/684,263, filed on Oct. 12, 2003.

(51) Int. Cl. G06F 12/08

(52) U.S. Cl. 711/203; 711/114; 711/209

(57) ABSTRACT

A tool for creating collections of data objects is described. The tool may include a basket or list pane control in an explorer frame that includes interfaces for receiving and displaying data objects, or shortcuts to data objects, that are selected by a user to be included in a collection such as a static list. The list pane control may be employed by itself to make collections, or it may be hosted by another software object, such as an explorer frame that contains both the list pane control and one or more user interfaces, such as a navigation pane, that a user can employ to navigate an operating system shell and provide data objects to the list pane control, which remains rooted in a single collection as the user navigates throughout the file system.

The present application is a continuation-in-part of, and claims priority from, co-pending application Ser. No. 10/684,263, filed Oct. 12, 2003, and having the title “Extensible Creation and Editing of Integrated Collections.”

### FIELD OF THE INVENTION

The present invention relates generally to computers and data stored thereon. More specifically, the invention relates to the creation and editing of collections of objects, such as lists, by providing a tool for creating and/or editing a collection of data objects, so that the objects can be manipulated as a collective unit.

### BACKGROUND OF THE INVENTION

As computers have become more and more ubiquitous in our culture, people from all walks of life have grown accustomed to using computers for a variety of tasks. For example, a high school student might use a personal computer to copy a group of music files to a digital music player, while a grandparent may employ a personal computer to send files of photographic images to a granddaughter or grandson. A business executive might then use a corporate computer networked to a central server to send and receive business application files, such as Microsoft® Word brand word processor and Microsoft® Excel brand spreadsheet files, by an electronic mail messaging service like Microsoft® Outlook brand email client.

While the uses of computers have grown in diversity and sophistication, the tools provided by computers for manipulating data need to become more diverse and sophisticated as well. In particular, while many users would like to be able to perform the same operation on multiple data files, most computers do not provide a convenient technique for creating a collection of data files to be manipulated simultaneously.

Some operating systems, for example, allow a user to select multiple files for simultaneous manipulation (e.g., by concurrently pressing the “control” key while selecting each file with a pointing device). Once the files have been selected, however, no action can be taken regarding a non-selected data file without destroying the grouping of the selected files. Also, all of the files must typically be selected from a single location, such as from within the same folder, and cannot be selected from separate locations.

Additionally, various specialized software applications may allow a user to group files into a collection for specific purposes. For example, a software application for playing music data files may allow a user to group music files into a playlist. These applications typically limit the user's manipulations of the group of files, however, to functions related to the software application. Moreover, a grouping feature provided by such a specialized software application typically cannot be used outside of the software application.

File manipulation, e.g., to create a group of files, has previously been limited to dragging and dropping files in a common folder. However, even dragging and dropping between multiple frames, or windows, is difficult and tedious for a user. On small screens, such as on laptop computers, it is even more difficult because the default window size on a laptop screen approximates the screen size. In order to drag and drop in such an environment a user must place the source window in focus, select the desired item(s), drag the selected item(s) to the target window's icon on the taskbar, wait for the target window to open with input focus, and then drop the selected item(s) into that window. If the user accidentally lets go of the mouse button during the operation the entire process may be aborted or, worse yet, the selected item(s) may be placed in an unintended location. The process become even more difficult if there are multiple windows open and all of the open folder windows (e.g., all open file browser windows) have merged into a single taskbar icon, as is prone to occur in the Microsoft® Windows® XP brand operating system, because the user must navigate not only to the icon on the taskbar, but also to a specific window represented in a popup list extending from that icon on the taskbar.

### BRIEF SUMMARY OF THE INVENTION

It therefore would be useful to have an architecture for creating and editing collections of data objects, so that the data objects can be manipulated as a unit, which addresses the above mentioned limitations in the prior art, as well as addresses other problems which will become apparent to the reader as aspects of the invention are discussed below. Moreover, it would be useful to have such a collection-creating architecture that is extensible across multiple software applications and platforms.

Advantageously, various examples of the invention provide a tool for creating integrated collections. With some implementations of the invention, the tool may include a “basket” control that receives objects to be included in a collection. The basket control, also referred to as a list pane, may, for example, include interfaces for receiving and displaying the data objects that are selected by a user to be included in a collection. A user may thus build a collection of data objects simply by providing the data objects to the basket control. A collection creation component then provides a collection with one or more data items corresponding to the objects submitted to the basket control. With various aspects of the invention, a collection can be compiled with any desired data objects, including discrete data (such as text), data files, pointers to data files, queries or exclusions for identifying data files based upon designated criteria, both virtual and physical folders containing one or more data objects, and even other collections of data objects.

The basket control may be employed by itself to make collections, or it may be hosted by another software object. For example, various implementations of the invention may additionally include a “listmaker” control that conveniently contains both the basket control and one or more user interfaces that a user can employ to provide data objects to the basket control. For example, the listmaker control may include a viewing graphical user interface (such as a file browser) for viewing data objects and a navigation toolbar for navigating the viewing graphical user interface. The listmaker control may then be hosted as desired by software developers in a variety of software applications.

One or more aspects of the invention may be directed to computer systems, stored software, and/or methods for creating a static list of data objects stored on a computer system. Aspects of the invention may display on a computer display device a graphical user interface (GUI) frame, e.g., an explorer frame, comprising a primary view pane and a list pane. The primary view pane displays data objects stored on the computer system in a first predefined location, e.g., a virtual or physical folder identified by a user, and the list pane displays information corresponding to items in a static list associated with the list pane. Each item in the static list corresponds to a data object, and includes information pertaining to the data object, e.g., a pointer to the data object, the item's order in the list, annotations regarding the item, etc. A user may provide input identifying a first data object displayed in the primary view pane to be added to the static list such that an item corresponding to the first data object is added to the static list. Information about the first item, e.g., icon, name, annotations, etc., may be displayed in the list pane. The user can specify a second predefined location, causing the primary view pane to display data objects stored in the second predefined location without changing the static list with which the list pane is associated.

According to various illustrative aspects of the invention, each static list may have a persistence model where the contents of the static list are discarded unless the user has expressed an intent, explicit or implied, to save the static list. Implied intent can be indicated by the user renaming the static list from a default name to a user-defined name.

### BRIEF DESCRIPTION OF THE DRAWINGS

FIG. 1 illustrates a computing environment in which various illustrative embodiments of the invention may be implemented.

FIG. 2 illustrates an example of a basket control according to various illustrative embodiments of the invention.

FIG. 3 illustrates a toolbar including navigational controls for navigating the basket control according to various illustrative embodiments of the inventions.

FIG. 4 illustrates a dialog box for creating a new collection of data objects according to various illustrative embodiments of the invention.

FIG. 5 illustrates an example of a listmaker control according to various illustrative embodiments of the invention.

FIG. 6 illustrates an explorer frame with an integrated list pane according to an illustrative embodiment of the invention.

FIG. 7 illustrates a context menu for a list object according to an illustrative embodiment of the invention.

FIG. 8 illustrates a portion of an explorer frame having task-based controls according to an illustrative aspect of the invention.

FIG. 9 illustrates an explorer frame with an integrated task-based list pane according to an illustrative embodiment of the invention.

### DETAILED DESCRIPTION OF THE INVENTION

Overview

Various implementations of the invention provide a tool for creating or editing a collection of data objects which when storing shortcuts or pointers to objects, and not a copy of the objects themselves, is referred to as a static list. A static list is a user-defined arbitrary collection of objects defined by an ordered selection of shortcuts or pointers to the included objects. A user can use a static list to organize items from arbitrary locations, including items stored locally and/or items stored remotely on one or more other machines. A collection of objects whereby a copy of each object is stored within the collection is referred to as an integrated collection. The below description refers to collections, integrated collections, and static lists, each having various features and capabilities. Those of skill in the art will appreciate from reading the below description that features described as belonging only to one (e.g., to only an integrated collection or to only a static list) may be a shared feature of all collections, as determined by the context of use by the collection, and is not limited by the below description unless explicitly called out below.

Each integrated collection or static list may include many different types of data objects, such as discrete portions of text, data files, queries or exclusions for identifying data files based upon designated criteria, both virtual and physical folders containing one or more data objects, and even other collections of data objects (e.g., other static lists). In addition to maintain a collection of objects, a static list can also store extrinsic data regarding each included object, including, e.g., the object's order in the list, as well as one or more textual annotations regarding the object. A user can thus write a comment about an item in a list without actually writing the comment back into the target object. Once a collection is created, all data objects in the collection can be simultaneously manipulated as an integrated unit.

Advantageously, various implementations of a tool according to the invention may be extended by software developers over a variety of software applications and platforms. For example, one or more implementations of the tool may be incorporated by a software developer into a software application, in order to allow a user of the application to make collections for the software application.

In another illustrative implementation, a list pane may be added to or included within a shell browser or explorer frame. The list pane may be a resizable pane that can be opened on a side of a shell browser frame next to the primary view of data objects, as further described below. Any existing static list can be opened in the list pane, or a user may use the list pane to create a new static list. The list pane may remain rooted in the static list being edited while the list pane is open, regardless of whether the user changes or navigates away from the folder, query, or view in the primary view pane of the shell browser frame. The list pane thus acts as an intuitive target for the user to drop objects into or drag objects out of a static list as the user navigates through a file system.

The list pane may also be referred to as a “basket” control. Using this type of control, a user may create collections of data objects simply by submitting the desired objects to the control. For example, the basket control may be employed with an operating system that uses a graphical user interface for receiving data objects. With this arrangement, a user may submit data objects to the basket control simply by moving an icon representing the desired data object into the user interface (e.g., a window) provided by the basket control (i.e., colloquially referred to as “drag and drop”). With various examples of the invention, the basket control may also include a collection creation component, which creates an integrated collection of data items corresponding to the objects provided to or pointed to by the basket control. For example, the collection creation tool may create a collection of entire copies of the data objects. Alternately, the collection creation tool may create a collection of pointers pointing to the selected data objects.

With some implementations of the invention, the basket control may be instantiated by itself. For example, the basket control may be provided as a stand-alone tool on a desktop of an operating system or hosted by another software object. Alternately, with various implementations of the invention, the basket control may be used in conjunction with one or more other software objects to improve the basket tool's usefulness. For example, the basket tool may be hosted by a “listmaker” control that conveniently contains both the basket control and one or more user interfaces that a user can employ to provide data objects to the basket control.

More particularly, a listmaker control may include a viewing graphical user interface (such as a shell or file browser) for viewing data objects and a navigation toolbar for navigating the viewing graphical user interface. This arrangement allows a user to select desired data objects with the viewing graphical user interface, and then add the selected data objects to a static list by submitting the selected data objects to the basket control, or list pane. Like the basket control, a listmaker control incorporating a basket control may be provided by itself, or hosted as desired in a variety of software applications

Operating Environment

Different embodiments of the invention may be implemented on a wide variety of computing devices. More particularly, a tool for creating integrated collections according to various examples of the invention may be implemented using computer-executable instructions, such as program modules, executed by one or more computing devices. Generally, program modules include routines, programs, objects, components, data structures, etc. that perform particular tasks or implement particular abstract data types. Typically, the functionality of the program modules may be combined or distributed as desired in various embodiments.

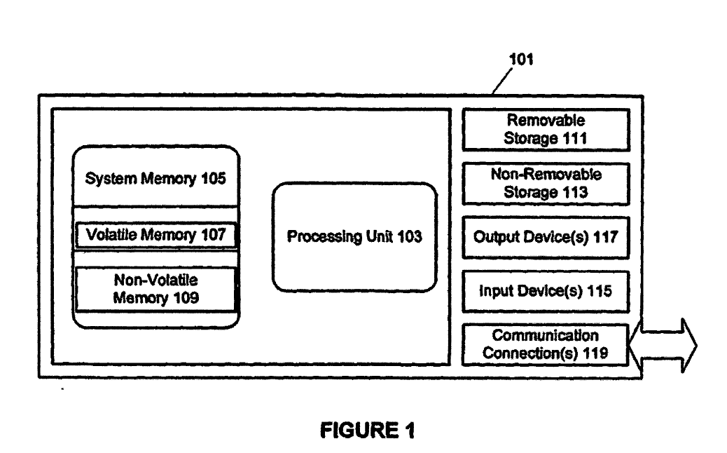

Because the invention may be implemented using software, it may be helpful for a better understanding of the invention to briefly discuss the components and operation of a typical, generalized programmable computer on which various embodiments of the invention may be employed. FIG. 1 illustrates an example of a computing device 101 that provides a suitable operating environment in which various embodiments of the invention may be implemented. This operating environment is only one example of a suitable operating environment, however, and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing device 101 typically includes at least some form of computer readable media. Computer readable media can be any available media that can be accessed by the computing device 101. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, punched media, holographic storage, or any other medium which can be used to store the desired information and which can be accessed by the operating environment 101.

Communication media typically embodies computer readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

With reference to FIG. 1, in its most basic configuration the computing device 101 typically includes a processing unit 103 and system memory 105. Depending on the exact configuration and type of computing device 101, the system memory 105 may include volatile memory 107 (such as RAM), non-volatile memory 109 (such as ROM, flash memory, etc.), or some combination of the two memory types. Additionally, device 101 may also have mass storage devices, such as a removable storage device 111, a non-removable storage device 113, or some combination of two storage device types. The mass storage devices can be any device that can retrieve stored information, such as magnetic or optical disks or tape, punched media, or holographic storage. As will be appreciated by those of ordinary skill in the art, the system memory 105 and mass storage devices 111 and 113 are examples of computer storage media.

The device 101 will typically have one or more input devices 115 as well, such as a keyboard, microphone, scanner or pointing device, for receiving input from a user. The device 101 will typically also have one or more output devices 117 for outputting data to a user, such as a display, a speaker, printer or a tactile feedback device. Other components of the device 101 may include communication connections 119 to other devices, computers, networks, servers, etc. using either wired or wireless media. As will be appreciated by those of ordinary skill in the art, the communication connections 119 are examples of communication media. All of these devices and connections are well know in the art and thus will not be discussed at length here.

The Basket Control

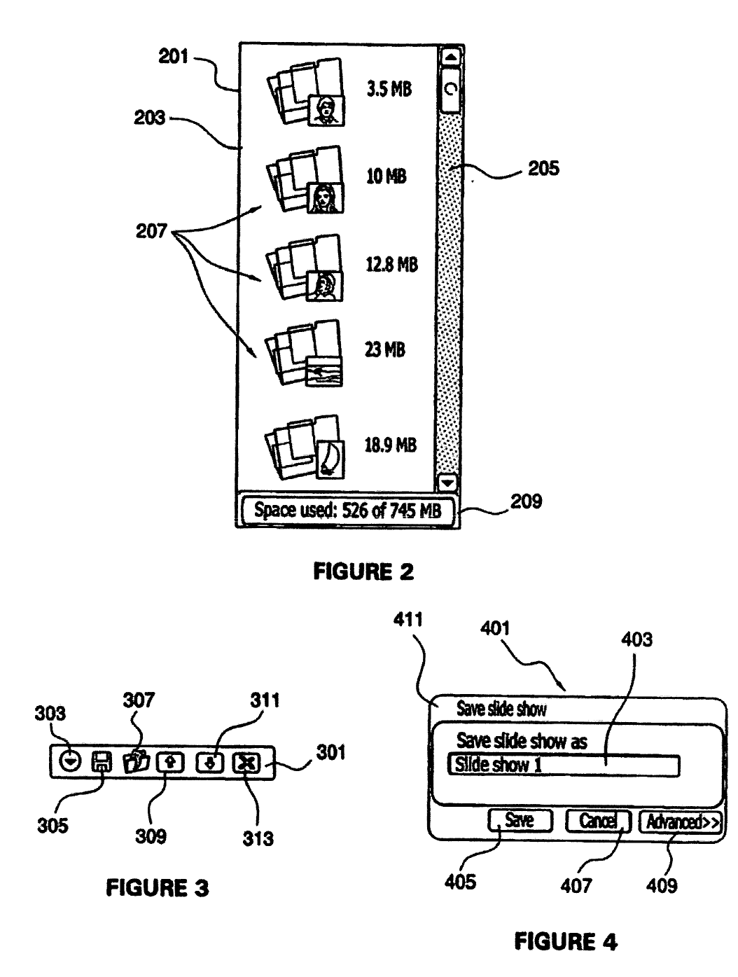

FIG. 2 illustrates one example of a basket control 201 (also referred to as a list pane) according to various embodiments of the invention. As illustrated in this figure, the basket control 201 includes a basket display area 203. The basket display area 203 may be a windowed graphical user interface, such as those provided in the Microsoft® Windows® XP operating system. The basket display area 203 may include any desired navigational controls for navigating through the basket display area 203. For example, as shown in FIG. 2, the basket display area 203 may include a conventional vertical scroll bar 205 for vertically scrolling through the basket display area 203. Of course, various implementations of the basket display area 203 may alternately or additionally include a horizontal scroll bar for horizontally scrolling through the basket display area 203.

As also shown in this figure, the basket display area 203 displays the representation of one or more data objects 207 to be included in a collection. With the illustrated example, the data objects 207 are data files, but various implementations of the invention may display the representation of any data object to be included in a collection, including, for example, a query or exclusion for identifying data files based upon designated criteria, and a virtual or physical folder, which may itself contain one or more data objects 207. Each data object 207 may represent a physical storage location, a virtual storage location (e.g., an autolist or a shell folder such as a control panel folder), a physical item (e.g., a data file stored in memory), a virtual item (e.g., an email, a contact, a task, a control panel item, etc.), or any other item that the operating system shell can represent as a unitary object, e.g., through a namespace extension.

In the embodiment of the invention shown in FIG. 2, the basket display area 203 serves both as a basket interface for receiving data objects 203 and a display interface for displaying the data objects included in the collection. With alternate embodiments of the invention, however, the display interface may be separate from the basket interface, or omitted altogether. Also, while the embodiment of the invention illustrated in FIG. 2 displays all of the data objects included in the collection (using scrolling or other navigational techniques, as necessary), still other embodiments of the invention might only illustrate a portion of the data objects included in the collection, such as data objects of a specific type or only data objects that were submitted to the basket control 201.

With the example of the basket display area 203 shown in FIG. 2, each data object 207 is represented by an abstract image corresponding to the type of the data object 207, coupled with a “thumbnail” image (i.e., a small image of the data in the data object 207) and an alphanumerical indication of the size of the data object 207. It should be noted, however, that other embodiments of the invention may additionally or alternately include more or less information representing the data objects 207, e.g., one or more user annotations of each object, such as comments. Also, various embodiments of the basket control 201 may allow a user or hosting software application to select what type of information is used to represent the data objects 207. For example, some embodiments of the invention may allow a user or hosting software application to select whether the basket display area 203 will display a thumbnail image, a “tile,” an “icon,” the alphanumeric name of the data object 207, or the alphanumeric name of the data object 207 coupled with various details relating to the data object 207, such as its size, date of creation, date of last modification, annotations or comments, etc.

Some embodiments of the basket control 201 may additionally include one or more status indicators, which may be used to show information regarding the integrated collection to be created from the data objects 207 represented in the basket display area 203. For example, in the illustrated embodiment, the status bar 209 shows an amount of storage space that would be occupied by the data objects 207 currently represented in the basket display area 203 relative to an amount of storage space associated with a collection (e.g., such as the amount of free storage space available on a compact disc onto which the collection might be saved). More particularly, the status bar 209 provides an alphanumeric indication of the amount of storage space that would be occupied by the data objects 207 relative to the total amount of storage space allocated for an integrated collection on a storage device. The status bar 209 also simultaneously provides a bar graph representation of the amount of storage space that would be occupied by the data objects 207 relative to the total amount of storage space allocated, e.g., for an integrated collection. It should be appreciated, however, that still other embodiments of the invention may display additional or alternate information in the status bar 209, such as information relating to aggregations or accumulations of properties, like counts of items, total size, total duration, etc.

For example, with some embodiments of the invention, if the basket control 201 is used to form collections from music files, then the status bar 209 may list the song titles corresponding to the data objects 207 in the basket control 201, and the total time (e.g., in the format Hours:Minutes:Seconds) required to listen to the data objects 207. Still further, various embodiments of the invention may include multiple status bars 209 to display any desired information relating to the data objects 207 represented in the basket display area 203. Moreover, with some embodiments of the invention, one or more of the status indicators may be selected for display by a user of the basket control 201 or, for example, a software developer providing the basket control 201 for a user, or hidden by the user or the software developer.

As noted above, the basket control 201 provides an interface that allows a user to select one or more data objects 207 to be included in a collection. For example, with various implementations of the invention, a user may include any data object 207 in a collection simply by submitting the desired data object 207 to the basket control 201. Thus, if the basket control 201 is implemented by an operating system that employs graphical user interfaces, such as the Microsoft® Windows® XP brand operating system, a user may add a data object 207 to a collection simply by moving a graphical representation of the desired data object 207 into the basket display area 203.

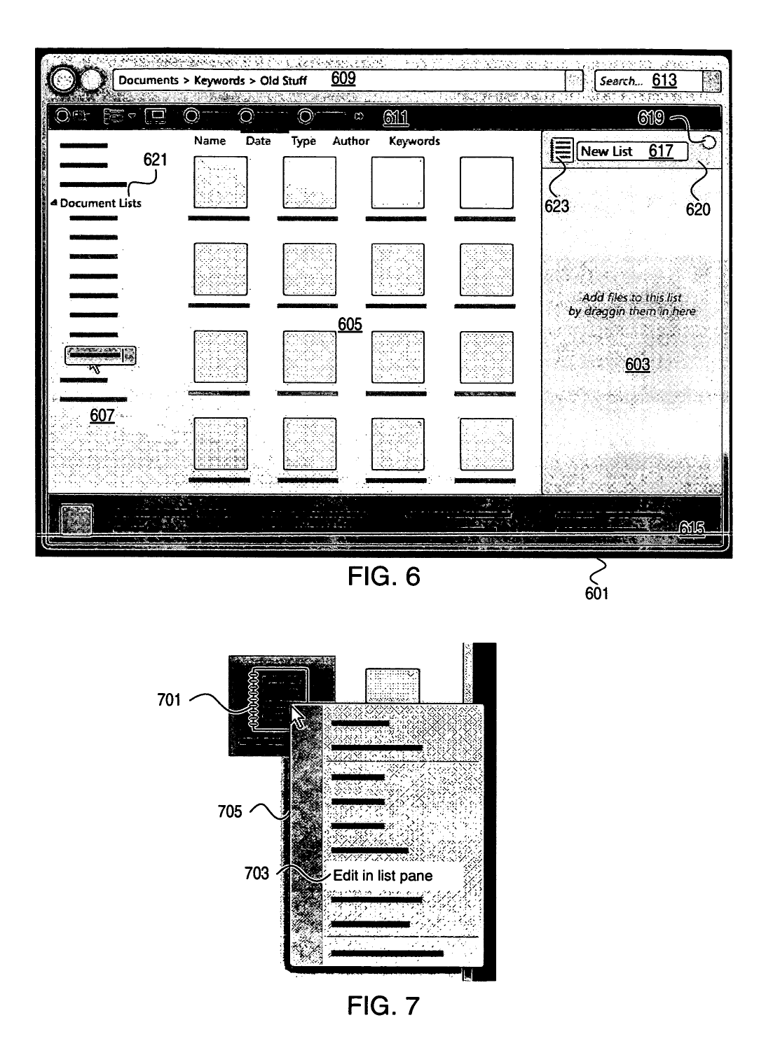

More particularly, if the basket control 201 is implemented using the Microsoft® Windows® XP brand operating system, then the basket control 201 may be formed as a list pane within the “Explorer view” software component (or a similar browser-type component used as an interface to both display and manipulate data objects), for example as illustrated with respect to FIG. 6, below. The basket control 201 may then include additional functionality to, for example, create copies of the submitted data objects 207 to be included in the collection, or shortcuts or pointers to the submitted data objects 207 to be included in the collection. This arrangement will allow users to submit a data object 207 to the basket control 201 by “dragging and dropping” a graphical user interface representation of the data object 207 (e.g., an icon) inside the basket display area 203 of the basket control 201 as conventionally known for other Microsoft® Windows® XP Explorer windows. Of course, any desired technique for submitting a data object 207 to the basket interface portion of the basket control 201, such as providing a command in a command (context) menu or submenu associated with the data object 207 or using a “paste” edit command to submit a previously copied file may alternately or additionally be employed.

It should also be noted that, with various examples of the invention, the basket control 201 may alternately or additionally be used to edit an existing collection. For example, a user may employ a command associated with a collection to instantiate a basket control 201 containing the data objects 207 (or pointers) corresponding to that collection. The user may then add one or more desired data objects 207 to the collection by submitting the desired data objects 207 to the basket control 201, or rearrange the order of data objects 207 if permitted by the collection.

With various embodiments of the invention, a user may employ the basket control 201 to exclude desired data objects 207 from a collection by withdrawing the desired data objects 207 from the basket control 201. For example, if the basket control 201 is implemented by an operating system that employs graphical user interfaces, such as the Microsoft® Windows® XP operating system, a user may prevent a data object 207 from being included in a collection simply by moving or deleting a graphical representation of the desired data object 207 from the basket display area 203. Further, with various examples of the invention, if the basket control 201 contains data objects 207 that are already included in an existing collection, a user may delete one or more desired data objects 207 from the existing collection by removing or deleting the representation of each desired data object 207 from the basket control 201. Of course, any desired technique for withdrawing a data object 207 from the basket control 201, such as providing a command in a command menu associated with the data object 207, may alternately or additionally be employed.

For some embodiments of the invention, the data items in a collection may be ordered according to predetermined criteria, such as, for example, alphabetical order of the names of the corresponding data objects 207 or the chronological order in which the corresponding data objects 207 were submitted to the basket control 201. With still other embodiments of the invention, however, the basket control 201 may be employed by the user to control the ordering of data items in a collection. More particularly, with various examples of the invention, a user may arrange the order of items in a data collection that permits ordering by ordering the representation of the data objects 207 corresponding to the collection in the basket control 201. Further, still other examples of the invention may allow a user of the basket control 201 or, for example, a hosting software application, to select whether the order of the representation of the data objects 207 determines the ordering of data items in the corresponding collection, or whether predetermined criteria determines the ordering of data items in the corresponding collection. If an implementation of the invention does allow for ordering data objects 207 as desired, it may include one or more functions to assist in the ordering of data objects 207. For example, the basket control 201 may provide the current order number next to the representation of each data object 207 in the basket display area 203.

Also, some types of data object collections may allow a user to create “active” collections. Thus, various examples of the invention may allow a user to include data items corresponding to active data objects 207, such as queries or exclusions (sometimes collectively referred to as “virtual folders” or autolists), which select or exclude one or more data objects 207 from a group of data objects 207 based upon designated criteria. For example, a query virtual folder for music data files may include all music data files within a data structure that the user played the previous day (i.e., “The music I listened to yesterday”). Of course still other embodiments of the invention may prohibit the use of active data objects 207, and create collections with data items corresponding to only “static” data objects 207. Alternately, with various embodiments of the invention, the basket control 201 may run the query or exclusion at the time a dynamic data object 207 is submitted, and add the results of the query or exclusion to the collection as flat data objects 207.

It should be noted that some types of data object collections may alternately or additionally allow a user to nest one or more data objects 207 within another data object 207, so as to form a multi-level hierarchy of data objects 207. Thus, various embodiments of the invention may allow a user to submit hierarchical data objects 207 to a collection. For example, a data object 207 submitted to the basket control 201 may be a “containing” data object 207 that may contain one or more other data objects 207, such as a folder or other collection. With these examples of the invention, a user may nest one or more data objects 207, such as data files, folders, or other collections within the containing folder in the basket control 201. Alternately, if a data object 207 already contains one or more other data objects 207, then a user may remove the one or more data objects 207 from the containing data object 207. Accordingly, if the basket control 201 includes a folder that contains one or more data files or other folders, then a user may remove these data files or other folders from the containing folder. The data objects 207 removed from a containing data object 207 may be withdrawn entirely from the basket control 201, or may simply be moved to another position within the basket control 201.

Of course, some types of collections might not permit the nesting of data objects 207. Thus, various embodiments of the invention may represent the data objects 207 submitted to the basket control 201 as “flat” and without a hierarchy. Moreover, even if a collection allows nested data objects 207, there may be some circumstances when a specific nesting of data objects 207 is not permitted. For example, if a data object 207 is a virtual folder corresponding to a query (i.e., an instruction to select files based upon designated criteria), then a user may be prohibited from nesting a data object 207 within that virtual folder that does not meet the designated criteria. With these examples (or where embodiments of the invention do not permit nesting of data objects 207), the basket control 201 may generate an error message if a user attempts to perform a prohibited nesting of data objects 207.

Additionally, some embodiments of the invention may allow a user to submit duplicate copies of a data object 207 to the basket control 201, while other embodiments of the invention may prohibit the inclusion of duplicate copies of a data object 207 in the basket control 201. With those embodiments of the invention that prohibit the inclusion of duplicate copies of data objects 207, the basket control 201 may create an error message when a user attempts to submit a data object 207 to the basket control 201 when the basket control 201 already includes a duplicate copy of that data object 207. Further, some embodiments of the invention may provide a menu command to remove duplicate copies of data objects 207 from a collection.

Still further, some embodiments of the invention may allow a user of the basket control 201 or, for example, a software developer providing the basket control 201 for a user, to select whether the basket control 201 will display data objects 207 as nested, or display the data objects 207 in a flat arrangement without a hierarchy. Some embodiments of the invention may also allow a user or a software developer to choose whether the basket control 201 will accept or prohibit active data objects 207, such as virtual folders, while still other embodiments of the invention allow a user or software developer to choose whether the basket control 201 will accept duplicate copies of a data object 207. Some embodiments of the invention may allow a user to select from among a combination of functional options for the basket control 201. For example, an embodiment of the invention may, by default, display the hierarchy of nested data objects 207 in a collection, but convert all active data objects 207 to static data objects 207 before forming the collection. The software application hosting the basket control 201 may be able to change this default setting, however, to have the basket control 201 prohibit nested data objects 207 and/or maintain active data objects 207.

Various examples of the basket control 201 may alternately or additionally include one or more navigation controls, such as navigation buttons contained in one or more toolbars. The navigation buttons may, for example, allow a user to view data objects 207 nested within other data objects (e.g., data files stored within folders), move up, down, left or right in the basket display area 203, or even delete data objects 207 from the basket control 201.

Because data objects 207 are submitted to the basket control 201 to form a collection, the basket control 201 may also include a component for finalizing a collection with the data objects 207 submitted to the basket control 201. For example, in addition to a status indicator and one or more navigation controls, the basket control 201 may additionally include a command button for forming a collection corresponding to the data objects 207 submitted to the basket control 201 (and thus represented in the basket display area 203). When a user is satisfied that the basket control 201 contains all of the data objects 207 that the user wishes to be included in a collection, the user may optionally cause a collection including copies of those data objects 207 to be created by activating the command button. It should be noted, however, that other command controls can alternately or additionally be employed to form a collection from data objects 207 submitted to the basket control 201.

FIG. 3 illustrates an example of a basket toolbar 301 that can be included in a basket control 201 according to various embodiments of the invention. As seen in this figure, the basket toolbar 301 includes both navigation controls and a collection creation control. More particularly, the basket toolbar 301 contains a “more commands” command button 303 and an “up” command button 307. The “more commands” command button 303 allows a user to view additional command provided by the basket toolbar 301, while the “up” command button 307 then navigates up one level in the hierarchy of data objects 207 displayed in the basket display area 203. It should be noted, however, that the “up” command button 307 may be hidden, omitted or inactive if the basket control 201 has been configured to maintain flat data objects 207, or if the collection prohibits nesting. This button 307 may also be hidden, omitted or inactive if the basket display area 203 is already displaying the top level of their basket control 201 or if the basket control 201 is empty.

The basket toolbar 301 also includes a “move up” command button 309 and a “move down” command button 311, which moves selected data objects 207 up or down in the ordering of data objects 207 in the basket control 201, respectively. These command buttons 309 and 311 may be hidden, omitted or inactive if the basket control 201 has been configured not to allow ordering of its contained data objects 207. Also, these command buttons may be hidden, omitted or inactive if no data objects 207 have been selected. Also, if the top data object 207 displayed in the basket display area 203 has been selected, then the “move up” button 309 may be hidden, omitted or inactive. Similarly, if the last data object 207 displayed in the basket display area 203 is selected, then the “move down” button 311 may be hidden, omitted or inactive. Still further, the basket toolbar 301 includes a “delete” command button 313, which removes selected data objects 207 from the basket control 201.

In addition to these navigation controls, the basket toolbar 301 may also include a “save collection” command button 305, for creating a collection (e.g., an integrated collection or a static list) corresponding to the data objects 207 contained in the basket control 201. With various embodiments of the invention, a user interface may be presented to the user when the user activates this button, to assist the user in determining various properties of the collection being created. For example, some embodiments of the invention may present the user with the save collection dialog box 401 shown in FIG. 4. As seen in this figure, the save collection dialog box 401 includes a name control 403, into which a user may enter the desired name of the collection being created. If the save collection dialog box 401 is provided to save an edit of a previously existing collection, then the name of that previously existing collection may be displayed in the name control 403. If the save collection dialog box 401 is being used to create a new collection, then the name control 403 may initially be blank. Alternately, the name control 403 may initially display a default name, such as “Collection [n]” where n is a number.

The save collection dialog box 401 also includes a “save” button 405, for actually creating a collection having the name provided in the name control 403 and including data items or pointers corresponding to the data objects 207 contained in the basket control 201 (with any extrinsic information), and a “cancel” button 407, for canceling the process of creating the collection. The save collection dialog box 401 may also include an “advanced button” 409, which may provide additional controls for determining the properties or other values related to the integrated collection being created.

It should be noted that, with various embodiments of the invention, different aspects of the user interface may be configured by a software application hosting the basket control 201. For example, with the save collection dialog box 401 illustrated in FIG. 4, the title 411 of the save collection dialog box 401 can be designated by the software application hosting the basket control 201. Thus, if the hosting software application relates to playback of music files, the title 411 of the save collection dialog box 401 may read “Save playlist.” On the other hand, if the hosting software application relates to the display of image files, then the title 411 of the save collection dialog box 401 may read “Save slide show,” as shown in this figure. Similarly, text above the textbox in the save collection dialog box 401 and other text inside of the text box may be configured as desired by the software application. Further, the file format of the collection being created may be determined by the software application hosting the basket control 201. Thus, a hosting software application that relates to the playback of music files may save the collection with a .wpl (Windows Play List) file format. If the hosting application does not designate a specific file format for the collection being created, then it may be assigned a default file format, such as a file format for a static list type of collection. In one illustrative embodiment, a default static list file format may be XML and/or RSS (really simple syndication) format, describer further below. One of skill in the art will appreciate that RSS may also been referred to as Rich Site Summary and RDF Site Summary, each of which can also or alternatively be used.

Further, the “save collection” command button 305 itself may be modified, hidden, omitted or rendered inactive by the software application. For example, the “save collection” command button 305 may be configured to display desired text. Thus, a hosting software application that relates to the playback of music may modify the “save collection” command button 305 to include the text “Save Playlist,” while a hosting software application that relates to the display of images may modify the “save collection” command button 305 to include the text “Save Slideshow.” Still further, the software application hosting the basket control 201 may omit the “save collection” command button 305 altogether. For example, as will be discussed in more detail below, the hosting software application may provide its own command controls for creating an integrated collection corresponding to the data objects 207 contained in the basket control 201.

As previously noted, for various embodiments of the invention the basket control 201 may be implemented as a list pane using conventional software techniques or components, such as the “Explorer view” software component provided in the Microsoft® Windows® XP Explorer software application. Conveniently, the basket control 201 may include some or all of the features of the Explorer view software component. For example, with some implementations of the invention, a user may be able to “double click” on a containing data object 207 (i.e., select the containing data object 207 and activate a command key, such as a key on a pointing device, twice) to navigate within the containing data object 207. Alternately or additionally, a user may be able to double-click on a file data object 207 to launch the software application that handles that type of file by default, in order to manipulate the file data object 207.

Further, a user may be able to “right-click” on a data object 207 (i.e., select the data object 207 and activate a different command key) to view a menu of commands (e.g., a context menu) for taking some action with respect to the selected data object 207. The menu may include conventional commands, such as “open,” “print,” “send to,” “cut,” “copy,” “delete,” “rename” and “[view] properties.” It should be noted, however, that in addition to or instead of the “delete” command, the menu provided for the data objects 207 may include a command to remove or withdraw the selected data object 207 from the basket control 201, as discussed in detail above. Still further, many embodiments of the invention may allow a user to change the view of the representation of the data objects 207 in the basket display area 203. For example, a user may be able to change the displayed view from icons for each data object 207 to an alphanumeric listing of each data object 207.

With some embodiments of the invention, the basket control 201 might not contain any data objects 207 when initially instantiated. In other embodiments of the invention, the basket control 201 may contain data objects 207 associated with the basket control 201 when it is initially instantiated. For example, as noted above, if the basket control 201 is associated with an existing collection, then the basket control 201 may initially include the data objects 207 associated with the data items in the collection. Also, if the basket control 201 is launched from a software application in which data objects 207 previously have been selected, then the basket control 201 may initially include those selected data objects 207.

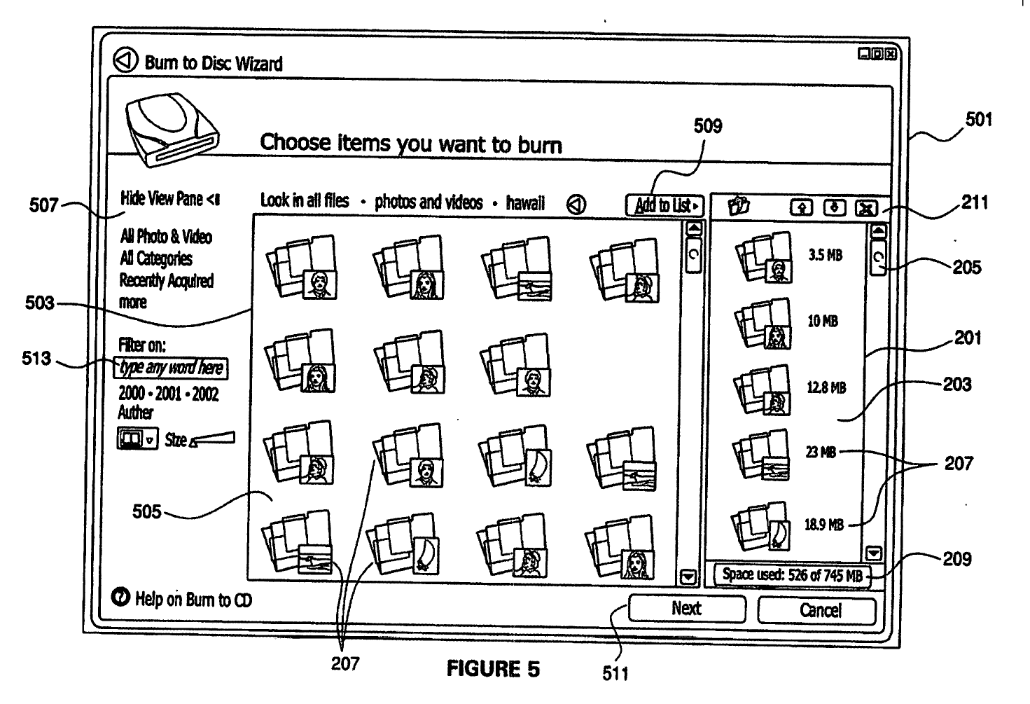

While the basket control 201 by itself provides a great deal of functionality, various embodiments of the invention may increase the usefulness of the basket control 201 by coupling it with other software applications or functionality. For example, as previously noted, some implementations of the invention may incorporate the basket control 201 as a list pane into a listmaker control 501, as illustrated in FIG. 5. The listmaker control may be implemented in or as a shell or file browser frame.

As seen in this figure, the listmaker control 501 contains the list pane (basket control) 201, including the basket display area 203, the vertical scroll bar 205, and the status bar 209, and a basket navigation toolbar 211 that includes navigational controls for navigating in the basket control 201, as described above. The listmaker control 501 also includes a navigational tool 503 for navigating to desired data objects 207. While the navigational tool 503 may be implemented using any desired type of navigational tool 503, various examples of the invention may implement the navigational tool 503 using a software application with graphical user interfaces, such as a shell or file browser or explorer application.

For example, in the embodiments of the invention illustrated in FIG. 5, the navigational tool 503 is implemented using the “Explorer view” component from the Explorer software application provided by the Microsoft® Windows® XP brand operating system. As seen in this figure, the navigational tool 503 employs several graphical user interfaces, including a navigational display area 505, a listmaker navigational toolbar 507, and a basket command toolbar 509. The navigational tool 503 provides these graphical user interfaces to assist a user in navigating to and identifying desired data objects 207, which are then graphically represented in the navigational display area 505. For example, the navigational tool 503 may include one or more navigational controls for navigating through a file structure, such as a list of available locations to be navigated and a control for selecting the type of data objects 207 (e.g., photograph files) to be displayed in the navigational display area 505.

The basket command toolbar 509 may then include one or more command controls for submitting data objects 207 identified by the navigational tool 503 to the basket control 201. In the illustrated example, the basket command toolbar 509 includes a command “Add to list.” Thus, after the user has selected one or more data objects 207 represented in the navigational display area 505 (using, for example, a pointing device such as a mouse or touchpad), the user can activate the command “Add to list” in order to submit the selected data objects 207 to the basket control 201.

Of course, in addition to (or instead of) commands provided in the basket command toolbar 509, various embodiments of the invention may allow a user to employ other techniques for submitting one or more data objects 207 identified by the navigational tool 503 to the basket control 201. For example, as previously noted, with some embodiments of the invention a user may “drag and drop” the representation of a data object 207 displayed in the navigational display area 505 to the basket display area 203 in order to submit that data object 207 to the basket control 201. With some embodiments of the invention, the representation of data objects 207 that have already been submitted to the basket control 201 may be highlighted or otherwise distinguished in the navigational display area 505.

In the embodiment of the invention illustrated in FIG. 5, the software application hosting the listview control 501 also provides a collection creation toolbar 511, for creating a collection corresponding to the data objects 207 submitted to the basket control 201. The collection creation toolbar 511 may include one or more command controls for creating a collection from the data objects 207 contained in the basket control 201. In the illustrated example, the listmaker control 501 is hosted by a software application “wizard” for burning data objects 207 to an optical storage disc, such as a DVD or CD. Accordingly, the collection creation toolbar 511 includes the commands “Next” and “Cancel” for creating a collection (or canceling the process of creating an integrated collection) by proceeding through the components of the wizard. Other embodiments of the invention, however, may provide command controls, such as command buttons, for expressly creating a collection or static list from the data objects 207 contained in the basket control 201 or in the listmaker control 501. Also, it should be noted that, while the illustrated embodiment of the invention includes a collection creation toolbar 511 with command controls for creating a collection, other embodiments of the invention may additionally or alternately include the collection creation toolbar 511 in the basket control 201, as previously explained, or in the listmaker control 201.

As noted above, the navigational tool 503 may be implemented using conventional software application components and functionality, such as the “Explorer view” component provided in, for example, the Microsoft® Windows® XP brand operating system Explorer software application. Accordingly, the navigational tool 503 may include some or all of the features of the Explorer view software component. For example, with some implementations of the invention, a user may be able to double click on a containing data object 207 to navigate within the containing data object 207, and alternately or additionally double-click on a file data object 207 to launch the software application that handles that type of file by default, in order to manipulate the file data object 207.

Further, a user may be able to right-click on the representation of a data object 207 in the navigational display area 505 to view a menu of commands for taking some action with respect to the selected data object 207. The menu may include conventional commands, such as “open,” “print,” “send to,” “cut,” “copy,” “delete,” “rename” and “[view] properties.” It should be noted, however, that the menu provided for the data objects 207 may additionally include a command to submit the selected data object 207 to the basket control 201.

Other embodiments of the invention may allow a user to change the view of the representation of the data objects 207 in the basket display area 203. For example, a user may be able to change the displayed view from an icon for each data object 207 to an alphanumeric listing of each data object 207. Also, various embodiments of the invention may allow a user to employ more sophisticated navigational tools, such as the view pane 513 illustrated in FIG. 5. The view pane 513 may be similar or identical to the view pane conventionally provided by the Microsoft® Windows® XP brand operating system Explorer view software component. Also, with some embodiments of the invention, the representations of data objects 207 in the navigational display area 505 (605 in FIG. 6) may be highlighted, shown in a given color, or otherwise distinguished if those data objects 207 already are represented by or included within the basket control 201. This easily identifies the data objects 207 in the navigational display 505 that have been submitted to the list pane basket control 201.

Moreover, with various embodiments of the invention, different features, properties and settings of the listmaker control 501 may be configured by a user or by a software application hosting the listmaker control 501 (i.e., by the software developer for the hosting software application). For example, the listmaker control 501 can be configured to open to a default starting location. Thus, if the hosting application is a software application related to the playback of music files, the application can designate that the navigational display area 505 initially display the representation of data objects 207 located in a portion of a data structure relating to music files, such as the “My Music” folder provided by the Microsoft Windows XP operating system. Similarly, if the hosting application is a software application related to the display of photographic images, the application can designate that the navigational display area 505 initially display the representation of data objects 207 located in a portion of a data structure relating to image files, such as the “My Pictures” folder provided by the Microsoft Windows XP operating system. If the software application has not designated a specific opening location for the listmaker control 501, then the listmaker control 501 may open to the last location accessed by the hosting software application or to a default location (such as the “My Documents” folder provided by the Microsoft Windows XP operating system).

The software application hosting the listmaker control 501 may also specify the file types that will be represented in the navigational display area 505 (and thus available to be submitted to the control basket 201). For example, if the hosting application is a software application related to the playback of music files, the application can designate that the navigational display area 505 initially display the representation of only data objects 207 having a music file type (e.g., .mp3 or .wma files). Similarly, if the hosting application is a software application related to the display of photographic images, the application can designate that the navigational display area 505 initially display only the representation of data objects 207 with an image file type, such as tif and jpg. file types.

Further, with some embodiments of the invention, a software application hosting the listmaker control 501 may specify the view provided by the navigational display area 505. The hosting software application may also specify whether the view pane will be initially displayed or hidden.

Accordingly, the listmaker control 501 provides software applications with a powerful tool for assisting a user in creating collections, such as integrated collections and static lists. Further, while the listmaker control 501 may incorporate all of the functionality of the basket control 201, it advantageously allows a hosting software application to provide users with additional functionality for creating collections. Moreover, this additional functionality can be configured by the software application to better correspond with the functionality and purpose of the hosting software application itself.

An additional illustrative embodiment will now be described with respect to FIGS. 6-9. FIG. 6 illustrates an explorer frame 601 having a list pane 603, primary view pane 605, and navigation pane 607. Explorer frame 601 may also include other features such as a breadcrumb bar 609 (alternatively referred to as a virtual address bar), menu bar 611, search window 613, and information or preview pane 615. List pane 603 may behave similar to basket control 201, described above. The list pane is thus a simple in-frame module available for a user to manipulate collections, e.g., static lists, in the context of the main explorer window.

Thus, for example, a user may create a to-do list and open the to-do list in the list pane 603, add several items to the to-do list while browsing the system shell via primary view pane 605, and then close the list pane 603, optionally saving the revised to-do list. As another example, a user may select certain photos stored across multiple folders viewed sequentially in primary view pane 605, place the selected photos in the list pane 603, and print the collection of photos by selecting all the photos in the list pane 603 by selecting print from a context menu or menu bar 611. The user can close the list pane with or without saving the new collection of photos, as desired.

A user may open the list pane by selecting a Window menu in menu bar 611, then selecting List Pane from the Window menu (not shown). Selecting Window|List Pane again may toggle the display status of the list pane 603, equivalent to Window|List Pane. In some embodiments a keyboard shortcut may be used, e.g., Ctrl-K, to toggle the list pane 603. The act of a user selecting Window|List Pane from the menu bar 611, or inputting Ctrl-K via a keyboard may be ambiguous as to whether the user desires to create a new persisted static list, or whether the user desires to gather a few items for an immediate task at hand, then close the list pane without saving the list. Thus, according to an embodiment of the invention, when a user opens the list pane 603, any objects in the list pane 603 are at least temporarily stored. If the user closes the list pane 603 without explicitly saving the static list, then the contents of the static list are discarded. However, the user may save the static list to persist the static list, e.g., to reuse the static list later, to or share the static list with others, etc. In one embodiment, the temporary storage location may be LocalAppData\Windows\Temporary List.wpl. Each explorer window opened by the user may have a unique temporary storage location associated with it for the purpose of storing the temporary static list until the user optionally affirmatively saves the static list.

The user can use the temporary list in the same manner that any other list in the basket is used. Items can be added, removed, re-ordered, etc. When the list pane 603 is open, the user can right-click on any item in the primary view 605 and choose “Add to List Pane” from a context menu (not shown) or view the menu bar 611, which will insert that item as a new last item in the list in list pane 603. The user may also drag and drop items into list pane 603. However, as this is a temporary list (similar to the “now playing” items in Windows® Media Player), the contents of this list are discarded when the user closes the frame 601 or closes the list pane 603. The system may optionally notify the user if there are unsaved contents in the list pane before closing the list pane 603 or frame 601.

If the user desires to save the temporary list, the user may select the title textbox 617, inputting a name for the list identified by the contents in list pane 603, and selecting the Save icon 619. Selecting the Save icon 619 may invoke the common file dialog to allow the user to select the location in which to store the static list. Alternatively, the user may context-select (e.g., right-click), in the list background, and select “Save . . . ” from the context menu, to invoke the common file dialog.

The user may also open the list pane 603 by selecting File|New|List from the menu bar 611, which will open the list pane 603 if it is previously closed. If the list pane is already open, selecting File|New|List results in the system discarding any items currently in the list pane 603 and creating a new temporary list. The new temporary list behaves just as a list created by the user selecting View|List Pane, and has the same persistence model (i.e., it is discarded when closed, unless the user first saves it).

The navigation pane 607 may include a lists node 621, which may be representative of all static lists created by the user, or of all static lists created by the user and stored in a specific location. A user may also be able to create a new list by context-selecting the lists node 621 and selecting “New List” from the context menu, which results in the frame 601 opening the list pane 603 with an empty list with a default title, e.g., “New List” or “New List (n)” where multiple default named new lists have been created. Optionally, in the navigation pane 607 the list name of the newly created list may automatically be in edit mode and/or the user may edit the list name in title text box 617 in the list pane 603. The new list is created in the default save location for the given explorer frame 601.

According to aspects of the invention, the list title may always be editable to input a new name for the list in list pane 603, which results in the system renaming the list on the storage device. If the user selects save button 619 for an already persisted list (i.e., the list is already saved), the system may perform as if the user selected a “Save as . . . ” option. Additionally, when the user selects File|New List from the menu bar 611, there might be no change to the state of appearance of the navigation pane. That is, if the lists node 621 is presently expanded, the new list appears hierarchically underneath the lists node 621, provided there is space available or its alphabetic insertion allows it to be viewable. However, if the lists node 621 is not presently expanded, then there is no visible change to the navigation pane 607. When the list in list pane 603 is empty, the list pane 603 may display a message indicating to the user how to create a list, e.g., “Add files to this list by dragging them in here.”

A user may double-click or otherwise select the list pane header 620 to close the list pane 603 and present the list contents in primary view 605. The user can alternatively press Shift+double-click to open a new explorer window rooted in the list displayed in list pane 603. The user can select the ‘X’ (or equivalent) in the uppermost right corner of the list pane 603 (not shown) to close the list pane 603 without any navigation in the primary view 605. When persisted lists are edited in the basket, there may be an explicit save model, where when the user closes the list pane 603 or the explorer frame 601, or navigates the list pane to another list, the system presents an explicit dialog box to ask the user whether the user desires to save any changes.

Items in the list pane 603 may exhibit similar behavior as items in primary view 605. For example, clicking or selecting any given item in the list pane 603 selects that item. When focus shifts between the primary view 605 and the list pane 603, both the primary view 605 and the list pane 603 may continue to reflect their selection state (using the soft-select state for whichever pane does not have input focus). However, only one pane truly has focus, which is reflected in the view as a visual cue to the user as to what the arrow keys will do. When focus is in the list pane 603, the same selection and keys may work as in the primary view 605—Ctrl+A to select all, arrow keys to move, etc.

Using the system described above, a user can drag and drop to and within the list pane 603, allowing the user to add, delete, re-order, and otherwise manipulate objects in a static list. When dragging into the basket, the system may provide various visual cues to the user. First, the explorer frame may highlight the outer edge of list pane 603 to indicate that the list pane 603 is an active drop target. The list pane may also provide an insertion bar (not shown) if there is more than one item in the list. As the user navigates the primary view 605, the list pane 603 remains rooted in a given list, which provides the user an efficient and simple mechanism by which to build up contents of a collection by navigating a file system in primary view 605 without requiring the user to engage in a plentitude of tedious cross-window drag-drops.

With further reference to FIG. 7, after a user creates and saves a list 701, the user may reopen the persisted list 701 in the list pane 603 by context-selecting the persisted list 701 to display a context menu 705 and selecting a context option 703 to open the list in the list pane 603. The user can select the list icon 623 in the list pane header 620 to select the entire contents of the list currently being edited in list pane 603. The user may context-select (e.g., right-click) the list icon 623 to display context menu 705. Optionally, the user may right-click and drag the icon 623 to a new location to move the storage location of the list or to make a copy of the list in a new location.

According to an aspect of the invention, a static list may have a task associated with it, e.g., “Print photos,” “Burn CD,” “Make movie from video clips,” etc. In such an embodiment, selection of the task may open a blank list with task-specific controls. Alternatively, when a user opens a static list with which a task is already associated, the list pane 603 may automatically display task specific controls dependent on the specific task. User interactions with the list pane 603 remain the same, however, there is an overall optimized task the user is pushed toward while in a task-based mode.

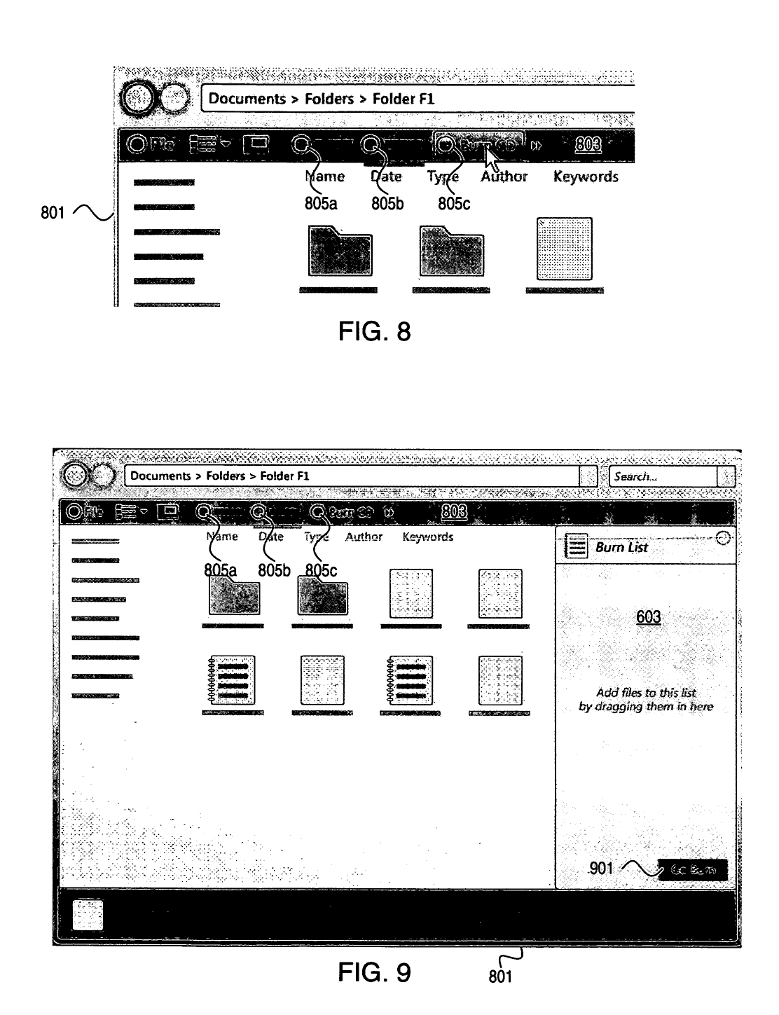

Thus, for example, FIG. 8 illustrates a portion of an explorer frame 801 prior to a user opening a list pane. The explorer frame 801 includes menu bar 803 having task options 805a, 805b, and 805c. Task 805c specifically refers to burning a CD. Tasks 805a and 805b might refer to, e.g., printing photos and making a movie from video clips, respectively. Upon selection of task 805c, the explorer frame opens list pane 603 with integrated task specific control 901, as further illustrated in FIG. 9. In this example the task specific control 901 provides the user the option to write the contents of the static list to a CD or other optical media or storage device. In such a scenario, the system may be adapted with logic to know that actual copies of the objects identified are to be written to the CD or other media, and not simply shortcuts, or pointers, to the objects if the collection is a static list. The objects identified by the list in list pane 603 may be written in their order prescribed by the static list, with annotations as applicable.

Task-based lists may also be temporary, and be discarded when the pane 603 or frame 801 is closed unless the user first saves the collection as described above. After the user completes the main task (burn, print, etc.) the task control 901 may automatically switch to be a “Save” button to re-emphasize that the user will otherwise lose the task-based list when the user closes the list pane 603 or frame 801.

The list pane 603 may be displayed in a countless number of ways with endless variations to display details, formats, etc., while still providing the functionality described above. Those of skill in the art will appreciate that the below description of an illustrative view is merely an example, and does not limit the scope of the invention as defined in the claims. Variations are possible depending on artistic design, allotted space, and the like. In one illustrative embodiment, the view state of the list pane may display tiles including 32×32 point icons with two rows of corresponding metadata. The icon size may optionally be locked (Ctrl+mouse may thus be disabled), or variable by the system and/or user. The list pane 603 may optionally limit horizontal resizing such that tiles are never shown side-by-side, which also assists the user to cognitively maintain the order of items in the collection by viewing their vertical order. Also, the list pane preferably only sorts and displays items by their order in the static list.

Various additional optional features may be included in one or more illustrative embodiments of the invention. For example, when the user closes the explorer frame and the list pane is open on a named list (e.g., one that has an explicit name and not the temporary default name), when the user next re-opens a like explorer frame the list pane may remain open to the list the user was previously viewing. If a temporary to-be-discarded list is in the list pane when the frame is closed, that list is discarded but the list pane may remain open (and empty) when the explorer frame is re-opened.

The list pane preferably opens as the rightmost pane, and may open by default to be 200 pixels wide. The cursor may become a resize grabber when hovering over the border between the list pane 603 and primary view 605. The list pane can be resized to a minimum width, e.g., 33 pixels, and the list pane size is preferably persisted per explorer frame. The list pane can also be resized to a maximum size, e.g., as large as the primary view 605 allows the list pane to grow (e.g., the list pane cannot be made larger than the smallest size of primary view 605). Those of skill in the art will appreciate that the default size may be other than 200 pixels, and that the list pane may be presented in a position other than the rightmost pane. For example, on a system wherein the language reads right-to-left (instead of left-to-right as in most western countries), the list pane may appear as the leftmost pane instead of the rightmost pane.

Interfaces for the Basket Control and the Listmaker Control

According to various examples of the invention, the basket control 201, the listmaker control 501, the list pane 603, or any or all may be implemented as software objects that can conveniently be hosting by a software application simply by accessing an interface for the software object. This type of interface, sometimes referred to as a “application programming interface,” allows a software application to both host the listmaker control 501 (or the basket control 201 or list pane 603) and designate specific settings for the listmaker control 501 (or the basket control 201 or list pane 603), without having to incorporate all of the software instructions required to implement the listmaker control 501 or the basket control 201.

A hosting application may thus employ an application programming interface that creates a collection. This application programming interface may, for example, include functionality to manage an ordered collection or list, such as functionality to insert an item (e.g., a data object 207) into the list, remove and item from the list, and get an item in the list.

Various examples of the invention may also provide an application programming interface that includes software instructions to create specialized types of collections, such as a playlist folder. This application programming interface, referred to hereafter as a “playlist” application programming interface, may employ the basic ordered collection application programming interface described above, but provide additional functionality to a collection. For example, a specialized collection application programming interface may provide a basic ordered collection with a “copy mode” property, which determines how data objects 207 will be copied into the collection. If the value of the property is “flat,” then the contents of nested data objects 207 will be flattened out when added to the collection. If, however, the value of the property is “not flat,” data objects 207 will retain their nested hierarchy when added to the collection. The value of the “copy mode” property may thus be specified by the hosting application to correspond to the use of the collection. Thus, a generic collection and a collection containing music files may have the “copy mode” property set to “flat,” while a collection for photographic images may have the copy mode set to “not flat.”

The playlist application programming interface may also provide a collection with a “web theme” property. This property determines, for example, background images that are displayed by the listmaker control 501 when accessing the collection. Thus, a generic collection may have a generic “web theme” property value of “list,” while a collection for music files may have a “web theme” property value of “playlist” (which may, e.g., instruct the listmaker control 501 to display music notes or instruments as background images). Similarly, while a collection for music files may have a “web theme” property value of “photo_album” (which may, e.g., instruct the listmaker control 501 to display a camera or a photo_album as background images). The playlist application programming interface may also provide a collection with a “perceived folder type” property, which determines how images representing folder data objects 207 are displayed.

The playlist application programming interface may also provide a collection with a “default columns” property, which defines the information displayed for a data object 207. For example, if the “default column” value may be set to “Name;Order;Artist;Album;Duration” for a collection of music files. When information for a data object 207 in the collection is then displayed, it will include the song name associated with the data object 207, the order of the data object 207 in the collection, the name of the artist associated with the data object 207, the name of the music album associated with the data object 207, and the duration of the music associated with the data object 207. On the other hand, the “default column” value may be set to “Name;Order” for a generic collection, so that only the name of each data object 207 and its order in the collection are displayed. Still further, the playlist application programming interface may provide a collection with an “order” property, which determines whether this collection will update its ordering of data objects 207 when a new data object 207 is added to or removed from the collection.

Various examples of the invention may also provide a basket control application programming interface that creates the basket control. This application programming interface will create a basket control object, which may be, for example, a simple browser software component (e.g., a list pane). The basket control application programming interface may then provide for various properties, methods, and notifications associated with the basket control. For example, the basket control application programming interface may include the property “RootFolder”, which may be readable and writable before the basket control is displayed. This property identifies the collection for which the basket control is created. If the value of this property is “null,” the basket control may create a temporary collection.

The basket control application programming interface may also include properties relating to how the data objects 207 in a collection and the information relating to the data objects 207 are displayed by the basket control. For example, the basket control application programming interface may include a property “flags,” which may be readable and writable before the basket control is displayed. This property defines various flags associated with the basket control. The value of this property may include, for example, “hidenavigation,” which hides the navigation buttons and commands, even if the collection supports them, “widelayout,” which causes the toolbar (or toolbars) to be left-aligned, hides the header, and provides additional space on the status bar for additional controls. This property may also have the value “hideorder,” which hides the ordering buttons and commands, even if the collection supports ordering.

The basket control application programming interface may also include the properties “VisibleColumns” and “ViewFlags,” both of which may be readable and writable. The “VisibleColumns” property defines what columns are displayed for the representation of a data object 207 in the basket display area 203, while the property “ViewFlags” property defines what flag are displayed for the representation of a data object 207 in the basket display area 203. The basket control application programming interface may also include a “ViewMode” property, which may be readable and writable. The “ViewMode” property determines the mode (e.g., icons, details, thumbnails), etc. for which the representation of data objects 207 in the collection will be displayed. Further, the basket control application programming interface may have a “Header,” property, which may be readable and writable, and which designates a header to be displayed in the basket control. Additionally, the basket control application programming interface may include a “WatermarkText” property, which may be readable and writable before the basket control is displayed, that determines text to be displayed when the basket display area 203 is empty.

The basket control application programming interface may also include one or more properties relating to the operation of the status bar. For example, the basket control application programming interface may include a property “StatusProperties,” which may be readable and writable before the basket control is displayed, and which defines the properties of the collection to be displayed (or the aggregations of which are to be displayed) by the status bar. The basket control application programming interface may also include the property “StatusText,” which may be both readable and writable, and which replaces the display of properties in the status bar with a string of text. If the value of this property is set to “null,” then the properties reappear in the status bar.

In addition, the basket control application programming interface may include one or more methods associated with the status bar. For example, the basket control application programming interface may include the method “SetStatusGauge(int isp, object maximum, string format),” which activates a gauge display, (e.g., a three-dimensional pie chart) for the associated property at the given index. The hosting application may use this method to activate a gauge display for one of the properties of the status bar. For example, the gauge display may be a three-dimensional pie chart that displays a pie slice proportional to the current aggregated value of the property, relative to the maximum value specified by the hosting application. Further, the hosting application may specify a string (e.g., a text string), which the basket control may use to format a textual description of the property, with tokens that are replaced by the property's current total and the maximum value. For example, the status bar may display the text “45 MB used out of 600 MB available.”

The basket control application programming interface may also include one or more notifications, for notifying other software components of events. For example, the basket control application programming interface may include the notification “FolderContentsChanged,” which sends an event message when the contents of the collection are modified.

Additionally, various embodiments of the invention may provide a listmaker application programming interface for creating a listmaker control. The listmaker control may be implemented from, for example, a simple browser software component and the basket control (e.g., list pane) created by the basket control application programming interface. Thus, the listmaker control application programming interface may include various properties relating to the browser component or the basket control. For example, the listmaker control application programming interface may include a property “FolderView,” which may be a read-only value that identifies the browser component employed by the listmaker control. Similarly, the listmaker control application programming interface may include a property “Basket,” which may be a read-only value that identifies the basket control employed by the listmaker control. Further, the listmaker control application programming interface may include a property “BasketWidth,” which may be a readable and writable value that specifies the width of the basket control within the listmaker control.

It should be noted that, while examples of various programming application interfaces have been described above, any of these application programming interfaces may employ additional or alternate properties, methods, and notifications, depending upon the functionality desired and the operating system environment in which the application programming interfaces will be used.

Conclusion

Those of skill in the art will appreciate that the above description is illustrative of various aspects of the invention, and that modifications can be made to suit various operating environments and user needs. While certain descriptions refer to a “basket” or “list pane,” one will appreciate that they may be synonymous. While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A method of creating a static list of data objects stored on a computer system, comprising steps of:
displaying on a computer display device a graphical user interface (GUI) frame comprising a primary view pane and a list pane, wherein the primary view pane displays data objects identifiable by the computer system in a first predefined location identified by a user, and wherein the list pane displays information corresponding to items in a static list associated with the list pane, wherein each item corresponds to a data object;
receiving user input identifying a first data object displayed in the primary view pane to be added to the static list;
adding to the static list a first item corresponding to the first data object;
displaying in the list pane information corresponding to the first item; and
in response to the user identifying a second predefined location, causing the primary view pane to display data objects stored in the second predefined location without changing the static list with which the list pane is associated,
wherein each data object comprises an item that the operating system shell can represent as a unitary object.

2. The method of claim 1, wherein the first predefined location comprises a physical storage folder, and the first data object comprises a data file.

3. The method of claim 1, wherein the first predefined location comprises a virtual location.

4. The method of claim 1, wherein the first predetermined location comprises a shell folder.

5. The method of claim 1, further comprising:
responsive to receiving user input to close the GUI frame, closing the GUI frame on the computer display device, and either:
discarding contents of the static list when the user has not previously indicated an intent to save the static list; or
saving contents of the static list when the user has previously indicated an intent to save the static list.

6. The method of claim 5, wherein the user previously indicating an intent to save the static list comprises receiving user input renaming the static list from a default name to a user-defined name.

7. The method of claim 1, wherein the user input identifying the first data object displayed in the primary view pane to be added to the static list comprises the user dragging and dropping the first data object from the primary view pane to the list pane.

8. The method of claim 1, wherein user input identifying the first data object displayed in the primary view pane to be added to the static list comprises the user selecting a menu item from a context menu associated with the first data object.

9. The method of claim 1, wherein the first item comprises a pointer to the first data object.

10. The method of claim 1, further comprising receiving user input editing the information corresponding to the first item by adding a comment corresponding to the first item.

11. The method of claim 1, further comprising receiving user input defining an order of the items in the static list.

12. The method of claim 1, further comprising displaying a task-based control in the GUI frame.

13. The method of claim 12, wherein displaying the task-based control comprises displaying a task action control in the list pane, and wherein the task action control is based on a task-type associated with the static list.

14. The method of claim 12, wherein displaying the task control comprises displaying a plurality of tasks in a menu in the GUI frame, and wherein the method further comprises receiving a user selection of one of the plurality of tasks to define a task type associated with the static list.

15. The method of claim 1, further comprising displaying a navigation pane in the GUI frame, the navigation pane adapted to receive user input selecting the first and second predefined locations from a hierarchical location tree displayed in the navigation pane.

16. The method of claim 15, wherein the hierarchical location tree comprises a lists node parenting one or more persisted static lists created by the user.

17. A computer readable medium storing computer executable instructions for performing the method of claim 1.

18. A computer system usable by a user for creating a static list, comprising:
a processor controlling overall operation of the computer system;
a video display for displaying a graphical user interface (GUI) for a user to interact with the computer system;
memory storing computer executable instructions which, when executed by the processor, perform a method for creating a static list, said method comprising steps of:
displaying on the video display device a graphical user interface frame comprising a primary view pane and a list pane, wherein the primary view pane displays data objects identifiable by the computer system in a first predefined location identified by a user, and wherein the list pane displays information corresponding to items in a static list associated with the list pane, wherein each item corresponds to a data object;
receiving user input identifying a first data object displayed in the primary view pane to be added to the static list;
adding to the static list a first item corresponding to the first data object;
displaying in the list pane information corresponding to the first item; and
in response to the user identifying a second predefined location, causing the primary view pane to display data objects stored in the second predefined location without changing the static list with which the list pane is associated.

19. The computer system of claim 18, said method further comprising:
responsive to receiving user input to close the GUI frame, closing the GUI frame on the computer display device, and either:
discarding contents of the static list when the user has not previously indicated an intent to save the static list; or
saving contents of the static list when the user has previously indicated an intent to save the static list.

20. A computer readable medium storing computer executable instructions which, when executed on a computer system, perform a method for creating an ordered static list, said method comprising steps of:
displaying on a computer display device a graphical user interface (UI) frame comprising a primary view pane and a list pane, wherein the primary view pane displays data objects identifiable by the computer system in a first predefined location identified by a user, and wherein the list pane displays information corresponding to items in an ordered static list associated with the list pane, wherein each item comprises a pointer to a data object;
receiving user input identifying a first data object displayed in the primary view pane to be added to the static list;
adding to the static list a first item comprising a pointer to the first data object;
displaying in the list pane information corresponding to the first item;
in response to the user identifying a second predefined location, causing the primary view pane to display data objects stored in the second predefined location without changing the static list with which the list pane is associated; and
in response to receiving user input to close the GUI frame, closing the GUI frame on the computer display device, and either:
discarding contents of the static list when the user has not previously indicated an intent to save the static list, or
saving contents of the static list when the user has previously indicated an intent to save the static list;
wherein each predetermined location comprises one of a virtual folder defined by metadata query and a physical folder defined by a storage location.
